(19) United States
(12) Patent Application Publication
(10) Pub. No.: US 2026/0024681 A1
(43) Pub. Date: Jan. 22, 2026

(54) RADIATING CABLES

(71) Applicant: RFS Technologies, Inc, Meriden, CT (US)

(72) Inventors: Asaad Ragab Elsaadani, Meriden, CT (US); Stephen Jeremia, Trumbull, CT (US); David Slack, Broad Brook, CT (US)

(73) Assignee: RFS Technologies, Inc., Meriden, CT (US)

(21) Appl. No.: 18/780,375

(22) Filed: Jul. 22, 2024

(51) Int. Cl. H01B 11/18; H01B 7/295

(52) U.S. Cl. CPC H01B 11/1869; H01B 7/295

(57) ABSTRACT

The techniques described herein relate to radiating cables. An example radiating coaxial cable includes a first conductor, a dielectric disposed over the first conductor, a second conductor comprising a plurality of slots, the dielectric being disposed between the first and second conductors, and a tape disposed over the second conductor configured to seal the plurality of slots, the tape having a thickness in a range of 0.5 to 2.0 mils.

### FIELD

The techniques described herein relate generally to radiofrequency coaxial cables and, more particularly, to radiating cables.

### BACKGROUND

A plenum space may refer to a space typically below a floor or above a ceiling through which air that has been cooled or heated by a heating, ventilation, or air conditioning (HVAC) can be distributed. In addition to being utilized for routing air, plenum spaces are often used to route network and telecommunication cables between locations. Such cables may be referred to as “plenum cables” since they are routed in plenum spaces. Plenum cables may also need to adhere to fire-safety standards set forth by national regulatory authorities or associations, such as the National Fire Codes series published by the National Fire Protection Association, which is a United States standard.

### SUMMARY

In accordance with the disclosed subject matter, example radiating cables are provided.

Some embodiments relate to an example radiating coaxial cable. The example radiating cable includes a first conductor, a dielectric disposed over the first conductor, a second conductor comprising a plurality of slots, the dielectric being disposed between the first and second conductors, and a tape disposed over the second conductor configured to seal the plurality of slots, the tape having a thickness in a range of 0.5 to 2.0 mils.

Some embodiments relate to another example radiating cable. The example radiating cable includes a first conductor, a dielectric disposed over the first conductor, a second conductor comprising a plurality of slots, the dielectric being disposed between the first and second conductors, and a tape disposed over the second conductor and the plurality of slots, the tape comprising at least one polyimide, and the tape having a thickness in a range of 0.5 to 2.0 mils.

Some embodiments relate to yet another example radiating cable. The example radiating cable includes a first conductor, a dielectric disposed over the first conductor, a second conductor comprising a plurality of slots, the dielectric being disposed between the first and second conductors, and a tape disposed over the second conductor and the plurality of slots, the tape comprising polytetrafluoroethylene (PTFE), and the tape having a thickness in a range of 0.5 to 2.0 mils.

The foregoing summary is not intended to be limiting. Moreover, various aspects of the present disclosure may be implemented alone or in combination with other aspects.

### BRIEF DESCRIPTION OF FIGURES

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1 is an isometric view of an example radiating coaxial cable configured with a star-shaped dielectric, according to some embodiments.

FIG. 2A is a side view of an example radiating coaxial cable configured with a fire-retardant tape, according to some embodiments.

FIG. 2B is an isometric view of the radiating coaxial cable of FIG. 2A, according to some embodiments.

FIG. 2C is an end view of the radiating coaxial cable of FIG. 2A, according to some embodiments.

FIG. 3A is a side view of an example radiating coaxial cable configured with a cross-shaped dielectric, according to some embodiments.

FIG. 3B is an isometric view of the radiating coaxial cable of FIG. 3A, according to some embodiments.

FIG. 3C is an end view of the radiating coaxial cable of FIG. 3A, according to some embodiments.

FIG. 4A is a plot of attenuation characteristics of the radiating coaxial cable of FIGS. 1, 2A, and/or 3A with respect to frequency, according to some embodiments.

FIG. 4B is a plot of coupling loss characteristics of the radiating coaxial cable of FIGS. 1, 2A, and/or 3A with respect to frequency, according to some embodiments.

FIG. 4C is a plot of return loss characteristics of the radiating coaxial cable of FIGS. 1, 2A, and/or 3A with respect to frequency, according to some embodiments.

FIG. 5A is a plot of flame spread with respect to time for a conventional radiating coaxial cable undergoing a flame test, according to some embodiments.

FIG. 5B is a plot of optical density with respect to time for a conventional radiating coaxial cable undergoing a flame test, according to some embodiments.

FIG. 5C is a plot of temperature with respect to time for a conventional radiating coaxial cable undergoing a flame test, according to some embodiments.

FIG. 6A is a plot of flame spread with respect to time for a conventional radiating coaxial cable undergoing a flame test and configured with fire-retardant tape, according to some embodiments.

FIG. 6B is a plot of optical density with respect to time for a conventional radiating coaxial cable undergoing a flame test and configured with fire-retardant tape, according to some embodiments.

FIG. 6C is a plot of temperature with respect to time for a conventional radiating coaxial cable undergoing a flame test and configured with fire-retardant tape, according to some embodiments.

FIG. 7A is a plot of flame spread with respect to time for the radiating coaxial cable of FIGS. 1, 2A, and/or 3A undergoing a flame test, according to some embodiments.

FIG. 7B is a plot of optical density with respect to time for the radiating coaxial cable of FIGS. 1, 2A, and/or 3A undergoing a flame test, according to some embodiments.

FIG. 7C is a plot of temperature with respect to time for the radiating coaxial cable of FIGS. 1, 2A, and/or 3A undergoing a flame test, according to some embodiments.

### DETAILED DESCRIPTION

The present application generally provides techniques for manufacturing, assembling, and/or constructing a radiating cable configured to transmit and/or receive radiofrequency (RF) energy. The radiating cable, which may also be referred to as a leaky cable, may be configured as a distributed antenna to provide communications in confined areas. Examples of confined areas include large building complexes, mines, and tunnels. Two or more radiating cables may be coupled together in an arrangement to form an electrical interconnection system, such as a system configured to effectuate communication (e.g., RF-based communication).

The radiating cables as disclosed herein may be plenum radiating cables (e.g., plenum rated radiating cables) when installed in plenum spaces. For example, a radiating cable as disclosed herein may be installed in a plenum space below a floor and above a ceiling in a building structure.

The radiating cables as disclosed herein may be radiating coaxial cables (or radiating coax cables), which are a type of cable constructed from multiple layers. For example, a radiating coaxial cable as disclosed herein may include an inner conductor (e.g., a central conductor) surrounded by one or more insulating layers (e.g., a dielectric), a conductive shield (e.g., a metal shield), and an outer jacket. Radiating coaxial cables may be configured with openings in the conductive shield to enable the transmission and/or reception of RF energy.

Radiating cables, such as plenum radiating cables, may be installed and/or otherwise disposed in areas that are regulated such that cables disposed therein are to conform with fire-safety standards. An example fire-safety standard is NFPA 262 published by the National Fire Protection Association (NFPA). NFPA 262 is a standard method of test for flame travel and smoke of wires and cables for use in air-handling spaces. This standard improves fire safety in air-handling spaces by presenting a test procedure to evaluate the potential for smoke and fire spread along cables and wires housed in a plenum or other air transport spaces. Another example fire-safety standard is UL 1685, which is published by Underwriters Laboratories (UL) and is a standard for vertical-tray fire-propagation and smoke-release test for electrical and optical-fiber cables. Radiating cables disclosed herein are not limited to being rated to only the aforementioned standards.

By way of example, NFPA 262 describes a flame test (which may be referred to as the “‘Steiner Tunnel’ Flame Test” or the “FT6 Horizontal Flame and Smoke Test”) to test whether a cable under test meets the fire-safety standard set forth by NFPA 262. The flame test as set forth by NFPA 262 is a standard method for measuring how insulated, jacketed, or both electrical wires and cables spread flames and generate smoke in simulated air handling plenums. The test procedure specifies that a 25-foot long Steiner Tunnel with intake and exhaust ducts be used to control airflow. Cable samples are mounted in a single layer on a tray in the tunnel, and two circular burners are mounted vertically at the tunnel's intake end, just in front of the tray. Methane is then burned through the tunnel at 240 feet per minute (ft/min) for 20 minutes, at which point the flame is extinguished. To pass the flame test, the maximum flame spread distance must be 1.5 meters (approximately 5 feet) or less, the maximum peak optical density must be 0.50 or less, and the average optical density must be 0.15 or less.

The inventor has recognized that conventional radiating cables, such as conventional plenum radiating coaxial cables, fail flame tests specified by fire-safety standards, such as NFPA 262. For example, the inventor has recognized that the outer conductor of conventional radiating cables has openings, for the transmission and/or reception of RF energy, that weaken the ability of the cables to resist fire and allows fire flames to spread quickly in fire situations, such as those simulated by the NFPA 262 flame test. Thus, when the outer jacket of conventional radiating cables is breached from excessive heat (e.g., melts) during the flame test, the outer conductor openings allow increased oxygen to flow in the cables, which expedites the flame travel from the presence of increased levels of combustible elements. In such an example, the one or more insulating layers of the conventional radiating cables burn and the flame travels along the length of the one or more insulating layers. Such conventional radiating cables thereby pose an enhanced fire risk in confined areas because of their ability to expedite flame travel.

The inventor has also recognized that the openings of conventional radiating cables have sharp edges that can cut into and/or through the outer jacket, which can create high stress concentration points along the cable. Due to these high stress concentration points, conventional radiating cables can be structurally weakened such that the outer jacket can crack relatively easily when bent in cold environments. In addition to weakening the structural integrity of the cable, the resulting cracks can also create openings through which oxygen can enter and cause flames to spread quickly along the interior (and/or exterior) of the cables.

Some conventional radiating cables include a fire-retardant tape between the outer conductor and the outer jacket. However, the inventor has recognized that the fire-retardant tape has limitations in flexibility (e.g., mechanical flexibility, bending flexibility) and flame performance.

First, the inventor has recognized that using fire-retardant tape in radiating cables is not effective in improving cable flexibility in cold environments. For example, the inventor has recognized that fire-retardant tapes, such as those made from glass woven fabrics (e.g., mica tape), adhere to the outer jacket and negatively affect the flexibility of the cable because of the increased friction between the fire-retardant tape and the outer jacket. In such an example, the reduced cable flexibility can also cause cracking in the outer jacket when the cable is bent in cold environments.

Second, the inventor has recognized that using fire-retardant tape in radiating cables is not effective in improving flame performance. For example, the inventor recognized that using fire-retardant tape does not improve flame performance in flame tests specified by fire-safety standards, such as NFPA 262. The inventor has recognized that fire-retardant tape, such as those made from glass woven fabrics, have micro holes that cannot be seen by human eyes but allow air and flames to travel through the cable and burn the dielectric inside the cable. Thus, due to the duration and severity of the NFPA 262 flame test, the outer jacket of conventional radiating cables is typically penetrated and the dielectric burns and coupled with the increased air flow by the fire-retardant tape micro holes, can cause flame travel to spread quickly and cause increased smoke levels, both of which cause failure of the flame test.

The inventor recognized the lack of flame travel effectiveness from fire-retardant tape usage during experimental testing. Specifically, the inventor facilitated the performance of an NFPA 262 flame test on two different radiating coaxial cables. The first radiating coaxial cable did not include any fire-retardant tape while the second radiating coaxial cable included fire-retardant tape between the outer conductor and the outer jacket. Both cables failed the flame test with the second radiating coaxial cable performing worse (e.g., more length of cable burned, increased smoke levels) than the first radiating coaxial cable.

The inventor recognized that the second radiating coaxial cable performed worse than the first radiating coaxial cable due to the presence of the fire-retardant tape. The fire-retardant tape is constructed from woven glass that is coated on both sides with a fire-retardant compound. The coating is applied to reduce the surface slipping with respect to the outer jacket. The temperature rating for the coated compound is approximately 752 degrees Fahrenheit (F) (e.g., 400 degrees Celsius (C)) while the temperature rating for the woven glass is approximately 1562 degrees F. (e.g., 850 degrees C.)). Specifically, the inventor recognized that once the outer jacket was penetrated, the fire-retardant tape, which is rated for high temperatures but lower than the temperatures of the NFPA 262 flame test (e.g., 600 degrees C. to 1500 degrees C. or approximately 1112 degrees F. to 2732 degrees F.), burned and provided additional flammable surface area, which led to increased smoke levels. The extreme conditions of the NFPA 262 flame test penetrated through the outer jacket and once the fire-retardant tape (and/or dielectric) caught fire, the flames rapidly traveled internally through the cable along the fire-retardant tape (and/or the dielectric).

To overcome the shortcomings of conventional radiating cables (e.g., radiating coaxial cables) in fire and extreme environment conditions (e.g., extreme cold or hot environments), the inventor has developed a plenum, flexible, sustainable, radiating cable as disclosed herein. As explained further below, the inventor has also developed the radiating cable to support sub-6 gigahertz (GHz) band for cellular networks, such as fifth generation cellular (5G) and next generation cellular (e.g., 6G) networks.

In some embodiments, the radiating cable is a radiating coaxial cable that includes a first conductor (e.g., an inner conductor), a dielectric disposed over the first conductor, and a second conductor (e.g., an outer conductor) with the dielectric being disposed between the first and second conductors. In some embodiments, the second conductor has a plurality of openings (e.g., slots), which can be configured to improve the transmission and/or reception of RF energy. In some embodiments, the radiating cable includes a tape disposed over the second conductor configured to seal the plurality of openings. In some embodiments, the tape has a thickness in a range of 0.5 to 2.0 mils (e.g., 0.0005 to 0.002 inches). A “mil” is a unit of thickness equal to one thousandth of an inch (e.g., 0.001 inches).

In some embodiments, the tape includes a fluoropolymer. In some embodiments, the tape includes a polymer including aromatic cycles or heterocycles. In some embodiments, the tape includes inorganic and/or semiorganic polymers. Beneficially, the inventor has recognized that a tape that includes fluoropolymer(s), polymer(s) including aromatic cycles or heterocycles, inorganic polymers, and/or semiorganic polymers enables improved flexibility, flame performance, and/or RF performance of radiating cables as disclosed herein with respect to conventional radiating cables.

The radiating cable developed by the inventor has improved flexibility performance with respect to conventional radiating cables. For example, in some embodiments, the dielectric may be a low-loss cellular polyethylene and/or the outer conductor may be a corrugated copper outer conductor, which enables a combination of improved flexibility, strength, and electrical performance with respect to conventional radiating cables. The tape disposed over the outer conductor as disclosed herein has less friction with the outer jacket with respect to the friction between fire-retardant tape and outer jackets of conventional radiating cables. For example, the tape as disclosed herein has a lower coefficient of friction than the coefficient of friction(s) associated with conventional radiating cables. The reduced friction enabled by the tape achieves increased flexibility with respect to conventional radiating cables.

Further, the radiating cable as disclosed herein is configured to be installed and/or operated in harsh environments such as extreme cold (e.g., ambient temperatures of −40 degrees Celsius (C)) and extreme heat (e.g., ambient temperatures of +90 degrees C.). By achieving improved flexibility with respect to conventional radiating cables, radiating cables as disclosed herein can be installed and/or operated in harsh environments with a reduced likelihood of breaking and/or cracking with respect to conventional radiating cables.

Further, the tape as disclosed herein can protect the outer jacket and seal the interior of the cable to reduce moisture. For example, the tape as disclosed herein can protect the outer jacket from potentially sharp edges of the openings of the outer conductor, which protects the cable from breaking and/or cracking. In another example, the tape can seal the interior of the cable to prevent and/or otherwise reduce moisture from accumulating internal to the cable, which correspondingly prevents and/or otherwise reduces corrosion to internal metallic components.

The radiating cable developed by the inventor has improved flame performance with respect to conventional radiating cables. For example, the tape as disclosed herein can be configured to seal a plurality of openings in the outer conductor of the radiating cable. Beneficially, by providing a seal (e.g., a continuous seal) for the plurality of openings, the tape can reduce the amount of oxygen that enters the interior of the cable and thereby substantially reduce the air and/or flame travel through the cable. Further, example tape materials as disclosed herein can withstand, at least for short time durations, temperatures as high as 700 degrees C. (1292 degrees F.), which can provide enhanced temperature protection with respect to conventional flame-retardant tapes.

The radiating cable developed by the inventor has improved RF performance with respect to conventional radiating cables. For example, the outer conductor can be configured with a plurality of openings that function as a distributed antenna. Openings on the outer conductor allow a controlled portion of the internal RF energy to be radiated into the surrounding environment of the cable. Additionally, an RF signal transmitted near the cable can couple into the openings and be carried along the cable length to effectuate wireless communication.

In some embodiments, the radiating cable can be configured to transmit and/or receive RF energy at frequencies up to 6 GHz. In some such embodiments, the radiating cable can be configured to effectuate 5G cellular communication and/or next generation cellular communication (e.g., 6G cellular communication). For example, the openings in the outer conductor can be slots (or a different geometric shape). In such an example, the respective sizes of the slots and/or the spacing between slots can be configured to support desired and/or intended operating frequencies and/or ranges. An example operating frequency range of the radiating cable developed by the inventor is 1 megahertz (MHz) to 6 GHz but other operating frequency ranges are contemplated, such as 75 MHz to 6 GHz.

In some embodiments, the tape as disclosed herein can enable the radiating cable to have improved RF performance with respect to conventional radiating cables. For example, the tape as disclosed herein can have a thickness in a range of 0.5 to 2.0 mils. In such an example, the tape is thinner than conventional fire-retardant tapes, which can have a thickness of 3.0 to 6.0 mils. RF performance decreases as tape thickness increases. Thus, the tape as disclosed herein has improved RF performance over conventional fire-retardant tapes because the tape as disclosed herein is substantially thinner than such conventional fire-retardant tapes. Accordingly, thinner tape as disclosed herein have improved RF performance over thicker tape. For example, tape having a thickness of 0.5 mils can have improved RF performance with respect to tape having a thickness of 2.0 mils.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

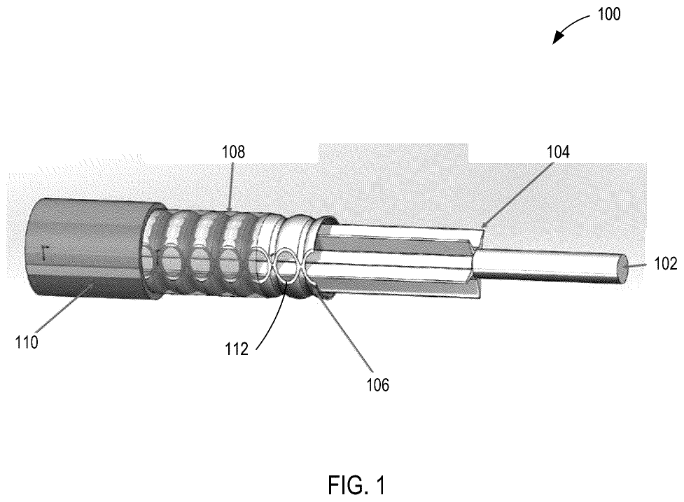

Turning to the figures, the illustrated example of FIG. 1 is an isometric view of an example radiating cable 100. Portions of the radiating cable 100 at a first end of the radiating cable 100 are removed to illustrate the construction of the radiating cable 100. The radiating cable 100 of this example is a coaxial cable, such as a radiating coaxial cable. The radiating cable 100 includes a first conductor 102, one or more insulating layers 104, a second conductor 106, a tape 108, and a jacket 110. The first conductor 102 is an inner conductor and the second conductor 106 is an outer conductor. The jacket 110 is an outer jacket of the radiating cable 100. Although not shown, the radiating cable 100 may be installed on a mechanical structure for ease of installation for a particular use case or application. An example mechanical structure is a cable reel. For example, tens, hundreds, or thousands of feet of the radiating cable 100 may be operatively coupled to a cable reel.

The first conductor 102 of this example is an electrical conductor. For example, the electrical conductor may be a wire. Examples of wire include a solid metal wire and a stranded metal wire. The first conductor 102 is metal. Examples of metal for the first conductor 102 include aluminum, copper, copper plated aluminum (CPA), copper cladded plastic, copper cladded aluminum (e.g., copper clad aluminum wire), and copper cladded steel (e.g., copper clad steel wire).

The one or more insulating layers 104 are and/or otherwise form a dielectric. The dielectric 104 can be configured to maintain consistent electrical properties and minimize and/or otherwise reduce signal loss for the radiating cable 100. For example, the material(s) and/or shape of the dielectric 104 can be configured to maintain consistent electrical properties and minimize and/or otherwise reduce signal loss for the radiating cable 100.

As shown in FIG. 1, the dielectric 104 is disposed over and/or coupled to the first conductor 102. The dielectric 104 of this example is a star-shaped dielectric. Alternatively, the dielectric 104 may have a different shape, such as a triangle or a cross.

The dielectric 104 has a thickness in range of 5 to 40 mils. For example, the dielectric 104 can have a thickness in a range of 15 to 29 mils. In some embodiments, the dielectric 104 has a nominal thickness around the first conductor 102 in a range of 5 to 15 mils. For example, the dielectric 104 can have a nominal thickness around the first conductor 102 in a range of 8 to 12 mils. In such an example, the dielectric 104 can have a nominal thickness of 10 mils around the first conductor 102.

The dielectric 104 may be constructed and/or formed from one or more polymers. Examples of the one or more polymers include homopolymers and fluoropolymers.

Examples of homopolymers include polyethylene (PE), high-density polyethylene (HDPE), polypropylene, polyvinyl chloride (PVC), and polyacrylonitrile (PAN). For example, the dielectric 104 can be a PE dielectric. In such an example, the dielectric 104 can be a cellular PE foam dielectric. In another example, the dielectric 104 can be a HDPE dielectric. In such an example, the dielectric 104 can be a cellular HDPE foam dielectric.

Examples of fluoropolymers include polyvinylfluoride (PVF), polyvinylidene fluoride (PVDF), polytetrafluoroethylene (PTFE), polychlorotrifluoroethylene (PCTFE), PFA, perfluoroalkoxy polymer (MFA), fluorinated ethylene-propylene (FEP), polyethylenetetrafluoroethylene (ETFE), polyethylenechlorotrifluoroethylene (ECTFE), Perfluorinated Elastomer (Perfluoroelastomer) (FFPM/FFKM), Fluoroelastomer (Vinylidene Fluoride based copolymers) (FPM/FKM), Fluoroelastomer (Tetrafluoroethylene-Propylene) (FEPM), Perfluoropolyether (PFPE), Perfluorosulfonic acid (PFSA), and Perfluoropolyoxetane. For example, the dielectric 104 can be a PTFE dielectric. In such an example, the dielectric 104 can be a cellular PTFE foam dielectric.

The second conductor 106 is a tube configured with a plurality of openings 112. The tube is metal. Examples of metal for the second conductor 106 include aluminum, copper, and copper cladded aluminum. For example, the second conductor 106 can be a copper tube.

In some embodiments, the second conductor 106 is milled to create the openings 112. For example, the second conductor 106 can be a continuous metal tube (e.g., a tube without openings) in which the individual openings 112 are milled. In some such embodiments, the continuous metal tube can be milled to reduce and/or otherwise eliminate imperfections, such as burrs or other sharpened and/or jagged edges.

The second conductor 106 of this example is corrugated by being shaped into alternate ridges and grooves. For example, the second conductor 106 can be a corrugated tube, such as a corrugated copper tube. In such an example, the second conductor 106 can be a welded corrugated copper tube.

In some embodiments, the second conductor 106 has a thickness in a range of 5 to 15 mils. For example, the second conductor 106 can have a thickness in a range of 8 to 12 mils. By way of example, the second conductor 106 can have a thickness of 10 mils.

As shown, the openings 112 are slots (e.g., slotted holes, slotted openings). Alternatively, the openings 112 may have a different shape, such as triangles, rectangles (e.g., squares), trapezoids, parallelograms, or a different shaped circle. The openings 112 are configured to function and/or operate as an antenna (e.g., a distributed antenna) to effectuate wireless communication. For example, the first conductor 102 can be configured to carry an electrical signal, which can be received from a surrounding environment of the radiating cable 100 and/or transmitted (e.g., radiated) to the surrounding environment. The openings 112 can be configured to allow a controlled portion of the internal RF energy of the electrical signal to be radiated into the surrounding environment. The openings 112 can be configured to allow a signal transmitted near and/or otherwise proximate to the radiating cable 100 to be coupled into the openings 112 and carried along the length of the radiating cable 100.

In some embodiments, the openings 112 can be configured to support wireless applications for a particular RF range. For example, the openings 112 and/or, more generally, the radiating cable 100 shown in FIG. 1 can be configured to support wireless applications in a range of 1 MHz to 6 GHz (e.g., a sub-6 GHz range). In such an example, the openings 122 can be configured to support wireless communication by effectuating the radiation of electromagnetic waves at frequencies of 600 MHz, 900 MHz, 1.8/1.9 GHz, 2.2 GHz, 2.4 GHz, 2.5 GHz, 2.7 GHz, 4.7 GHz, and 6 GHz. Alternatively, the openings 112 may be configured to support a different RF range such as a range and/or spectrum of 75 MHz to 6 GHz or a range of 4.4 GHz to 5 GHz.

In some embodiments, the openings 112 can be configured to effectuate cellular communication, such as fifth generation cellular (5G) communication and/or next generation cellular (e.g., 6G) communication. Alternatively, the openings 112 can be configured to effectuate a different type of wireless communication, such as Wireless Fidelity (Wi-Fi). In some embodiments, the openings 112 and/or, more generally, the radiating cable 100, can be configured to effectuate and/or implement networks, such as in-aircraft, in-train, vehicle-to-everything (V2X), and satellite networks.

In some embodiments, the openings 112 and/or, more generally, the radiating cable 100, can be configured for both one-way and two-way communication systems. Beneficially, because of its broadband capability by way of its wide range of supported frequencies (e.g., 1 MHz to 6 GHz), a single instance of the radiating cable 100 can handle multiple communication systems simultaneously.

In some embodiments, the size and/or spacing of the openings 112 can be configured to accommodate different RF ranges. For example, respective sizes of the openings 112 can be changed, such as made smaller or larger, to change the RF range supported by the radiating cable 100. Additionally or alternatively, respective spacings of the openings 112 along the length of the radiating cable 100 can be changed, such as by increasing or decreasing the spacings, to change the RF range supported by the radiating cable 100.

As shown, the second conductor 106 is disposed over the first conductor 102 and the dielectric 104. For example, the second conductor 106 is a tube configured with an opening therein in which the first conductor 102 and the dielectric 104 are disposed. Accordingly, the first conductor 102 has a first diameter that is less than a second diameter of the second conductor 104. For example, the first conductor 102 can have a diameter in a range of 3 to 6 millimeters (mm). Furthering the example, the second conductor 106 can have a diameter in range of 10 to 16 mm. In some such examples, the first conductor 102 can have a first diameter of 4.8 mm and the second conductor 104 can have a second diameter of 13.8 mm.

The tape 108 of the illustrated example is disposed over the second conductor 106 and also over the dielectric 104 and the first conductor 102. For example, the tape 108 may be wrapped and/or otherwise disposed around an outer surface of the second conductor 106. Although the tape 108 is shown as translucent for enhanced clarity of the construction of the radiating cable 100, the tape 108 may not be translucent. Alternatively, the tape 108 may be replaced with a jacket disposed over the second conductor 106.

The tape 108 may be constructed and/or formed from one or more polymers. Examples of the one or more polymers include fluoropolymers, inorganic, and semiorganic polymers.

Examples of fluoropolymers include PTFE, PVF, PVDF, PCTFE, PFA, MFA, FEP, ETFE, ECTFE, FFPM/FFKM, FPM/FKM, FEPM, PFPE, PFSA, and Perfluoropolyoxetane. For example, the tape 108 can be PTFE tape.

Examples of inorganic and/or semiorganic polymers include silicon-nitrogen, boron-nitrogen, and phosphorous-nitrogen polymers. For example, the tape 108 can be constructed from at least one of a silicon-nitrogen polymer, a boron-nitrogen polymer, or a phosphorous-nitrogen polymer.

In some embodiments, the fluoropolymers have a dielectric strength of at least 8,000 volts (V), 9,000 V, 10,000 V, etc. In such an example, the tape 108 can be constructed from one or more fluoropolymers having respective dielectric strengths of at least 9,000 V.

In some embodiments, the fluoropolymers have a dielectric strength of at least 15,000 V, 16,000 V, 17,000 V, etc. In such an example, the tape 108 can be constructed from one or more polymers having respective dielectric strengths of at least 16,000 V.

In some embodiments, the tape 108 is constructed and/or formed from a polymer including aromatic cycles or heterocycles. In some embodiments, the polymer is selected from a group consisting of Polyimides, polybenzoxazoles (PBOs), polybenzimidazoles, and polybenzthiazoles (PBTs). In some embodiments, the polymer is and/or includes a ladder polymer. By way of example, the tape 108 can be a Polyimide tape (which may also be referred to as “Pi tape”) and/or otherwise include one or more Polyimides.

In some embodiments, the tape 108 can be treated and/or modified using one or more materials that are fire safe and/or have fire retardant properties. For example, one or more of natural fiber, clay, silica, titania, carbon nanotubes, polyhedral silsesquioxanes, and/or layered double hydroxides may be added to the tape 108 (e.g., an outer surface of the tape 108). In some such embodiments, the one or more materials may be added to one or both sides of the tape 108.

The tape 108 of the illustrated example has a thickness in a range of 0.5 to 2.0 mils. For example, the tape 108 can have a thickness in a range of 0.95 to 1.05 mils. By way of example, the tape 108 can have a thickness of 1.0 mils. RF performance decreases with thicker tape. Accordingly, thinner tape 108 has improved RF performance over thicker tape 108. For example, the tape 108 having a thickness of 0.5 mils can have improved RF performance with respect to the tape 108 having a thickness of 2.0 mils.

The tape 108 of the illustrated example has a width in a range of 0.5 to 2.0 inches. For example, the tape 108 can have a width in a range of 0.5 to 1.5 inches. In another example, the tape 108 can have a width in a range of 0.95 to 1.05 inches. By way of yet another example, the tape 108 can have a width of 1 inch.

In some embodiments, the width of the tape 108 is selected based on the outside diameter of the cable. For example, wider tape can be used for larger diameter cables and thinner tape can be used for smaller diameter cables.

The jacket 110 of the illustrated example is configured to seal and/or protect the interior of the radiating cable 100. In some embodiments, the jacket 100 is halogen free, non corrosive, flame and fire retardant, and/or low smoke. In some embodiments, the jacket 100 is constructed using one or more fluoropolymers. Examples of the jacket 100 include a PVC jacket, a PVDF jacket, a fluorinated ethylene propylene (FEP) jacket, and a polyolefin jacket.

In some embodiments, the jacket 110 has a thickness in a range of 25 to 50 mils. For example, the jacket 110 can have a thickness in a range of 30 to 40 mils. By way of example, the jacket 110 can have a nominal thickness and/or an average thickness of 38 mils. By way of yet another example, the jacket can have a minimum thickness of 30 mils along the length of the radiating cable 100.

Beneficially, the tape 108 as disclosed herein enables the radiating cable 100 to have improved mechanical performance with respect to conventional radiating cables. For example, the tape 108 can have a coefficient of friction less than conventional fire-retardant tapes. In such an example, the tape 108 can have less friction with the jacket 110 with respect to the increased friction between conventional fire-retardant tapes and corresponding outer jackets of conventional radiating cables. Beneficially, the reduced level of friction between the tape 108 and the jacket 110 increases the durability of the radiating cable 100 by reducing the likelihood of breaking and/or cracking the radiating cable 100 in extreme environments, such as extreme cold environments. Additionally, the reduced level of friction enabled by the tape 108 achieves improved bending performance with respect to conventional radiating cables that have increased friction between their outer jackets and fire-retardant tapes.

Further, the tape 108 can cover the potentially sharp edges from the openings 112 such that the openings 112 do not contact the jacket 110. By protecting the jacket 110 from the potentially sharp opening edges, the tape 108 can enable the radiating cable 108 to have improved durability and a reduced likelihood of breaking and/or cracking when bent in extreme temperatures, such as temperatures approaching −40 degrees C., with respect to thicker flame-retardant tapes used in conventional radiating cables. For example, thicker flame-retardant tapes than the tape 108 can cause conventional radiating cables to have a reduced bending radius with respect to the radiating cable 100, which may be thinner due to the tape 108.

Beneficially, the tape 108 as disclosed herein enables the radiating cable 100 to have improved RF performance with respect to conventional radiating cables. For example, the tape 108 of the illustrated example can have a thickness that is less than a thickness of conventional flame-retardant tapes. By having a thinner barrier between the dielectric 104 and the second conductor 106, the tape 108 can have a reduced impact on RF performance (e.g., attenuation) with respect to thicker flame-retardant tapes, which have a larger negative impact on RF performance (e.g., attenuation).

Beneficially, the tape 108 as disclosed herein enables the radiating cable 100 to have improved flame performance with respect to conventional radiating cables. For example, the tape 108 provides a continuous seal over the second conductor 106, which contrasts the micro holes of conventional flame-retardant tapes. By providing a continuous seal over the second conductor 106, reduced levels of oxygen are present in the interior of the radiating cable 100, such as in the space between the second conductor 106 and the dielectric 104, with respect to increased levels of oxygen present in conventional radiating cables due to the micro holes allowing oxygen to enter the interior of such cables. Accordingly, the tape 108 enables reduced levels of oxygen in the radiating cable 100, which can reduce the flame path and smoke generation in the event that the jacket 110 is breached responsive to fire conditions.

Beneficially, the tape 108 as disclosed herein is configured to reduce an amount of at least one of the outer jacket 110 or the dielectric 104 consumed in fire conditions (e.g., a flame test, fire or flame conditions outside a flame test), and the reduced amount of the at least one of the outer jacket 110 or the dielectric 104 causes at least one of reduced smoke generation, ambient temperature, or flame travel in the fire conditions as described further herein.

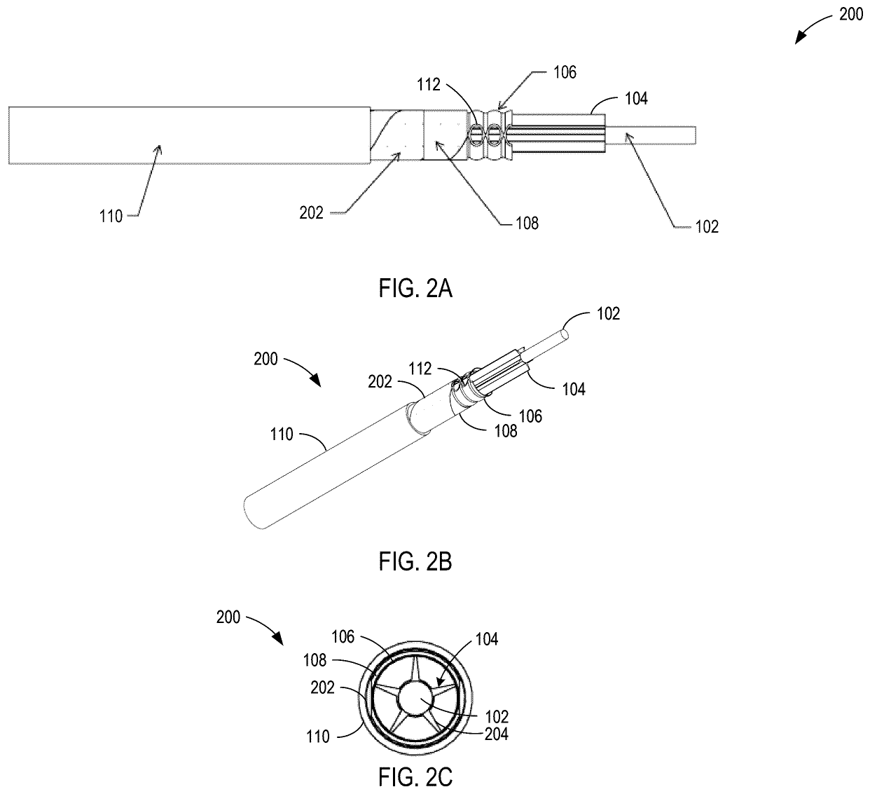

FIG. 2A shows a side view of another example radiating cable 200. Portions of the radiating cable 200 at a first end of the radiating cable 200 are removed to illustrate the construction of the radiating cable 200. The radiating cable 200 of this example is a coaxial cable, such as a radiating coaxial cable. The radiating cable 200 includes the first conductor 102, the dielectric 104, the second conductor 106, the tape 108, the jacket 110, and the openings 112 of FIG. 1.

The radiating cable 200 of the illustrated example further includes a fire-retardant tape 202. As shown, the fire-retardant tape 202 is disposed over the tape 108 and between the jacket 110 and the tape 108. For example, the fire-retardant tape 202 may be wrapped and/or otherwise disposed around an outer surface of the tape 108.

In some embodiments, the fire-retardant tape 202 can be constructed from glass woven fabrics. For example, the fire-retardant tape 202 can be mica tape, which can include mica paper. Additionally and/or alternatively, the fire-retardant tape 202 may be constructed from ceramic woven fabrics and/or silica woven fabrics.

In some embodiments, the fire-retardant tape 202 can have a width in a range of 0.5 to 2.0 inches. For example, the fire-retardant tape 202 can have a width in a range of 0.75 to 1.25 inches. In another example, the fire-retardant tape 202 can have a width in a range of 0.95 to 1.05 inches. By way of yet another example, the fire-retardant tape 202 can have a width of 1 inch.

In some embodiments, the fire-retardant tape 202 can have a thickness in a range of 0.05 mm to 0.1 mm. For example, the fire-retardant tape 202 can have a thickness of 0.05 mm, 0.1 mm, or a value in between 0.05 mm and 0.1 mm.

Beneficially, the fire-retardant tape 202 shown in FIG. 2 can provide an additional barrier between fire flames in a surrounding environment and the tape 108. For example, the fire-retardant tape 202 can provide additional heat insulation to the radiating coaxial cable 200 and protect the tape 108 and the dielectric 104 from direct exposure to the flame in fire conditions. By way of example, the radiating cable 200 can be advantageous and/or beneficial in applications in which flame performance is prioritized. In such an example, when the jacket 110 is penetrated due to extreme heat and/or fire conditions in the surrounding environment of the radiating cable 200, the fire-retardant tape 202 can provide a further barrier between the environment and the tape 108.

FIG. 2B is an isometric view of the radiating coaxial cable 200 of FIG. 2A.

FIG. 2C is an end view of the radiating coaxial cable 200 of FIGS. 2A and 2B. As shown in FIG. 2C, the dielectric 104 is a star-shaped dielectric. The star shape in this example has 5 fins 204 extending away from the first conductor 102. Alternatively, the dielectric 104 may have fewer or more than 5 of the fins 204. The respective fins 204 may be configured to have a length (e.g., a distance from the outer surface of the first conductor 102 to the inner surface of the tape 108) and/or a thickness to support wireless applications in a particular frequency range.

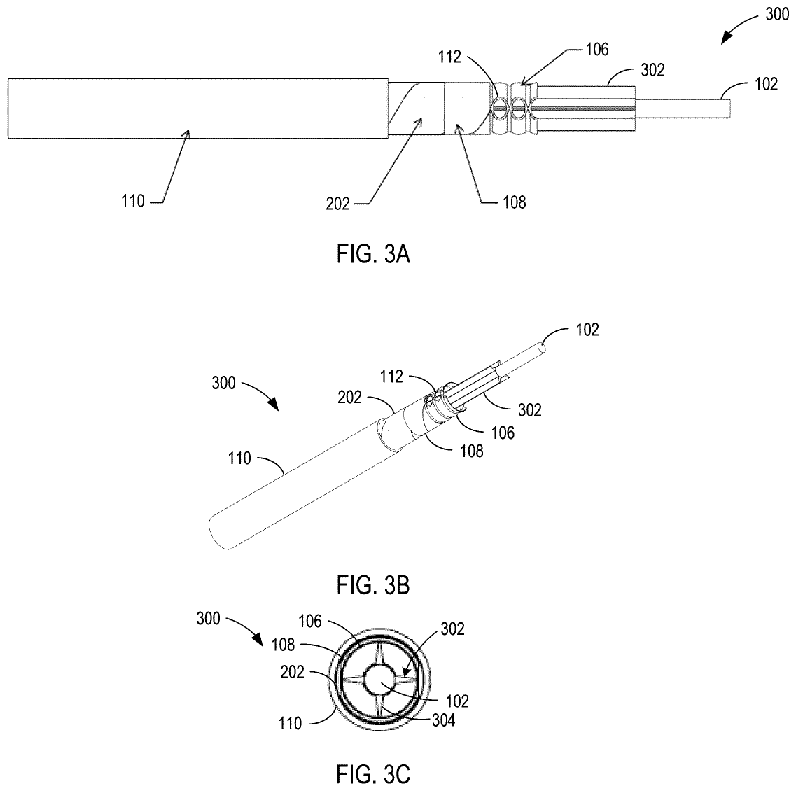

FIG. 3A is a side view of an example radiating coaxial cable 300 configured with a cross-shaped dielectric 302. Portions of the radiating cable 300 at a first end of the radiating cable 300 are removed to illustrate the construction of the radiating cable 300. The radiating cable 300 of this example is a coaxial cable, such as a radiating coaxial cable. The radiating cable 300 includes the first conductor 102, the second conductor 106, the tape 108, the jacket 110, and the openings 112 of FIG. 1 and the fire-retardant tape 202 of FIGS. 2A-2C. Alternatively, the radiating coaxial cable 300 of FIG. 3A may not include the fire-retardant tape 202.

The radiating cable 300 of the illustrated example further includes another example dielectric 302. As shown, the dielectric 302 is disposed over the first conductor 102 and between the second conductor 106 and the first conductor 102. For example, the second conductor 106 is configured with an opening through which the dielectric 302 and the first conductor 102 are disposed.

FIG. 3B is an isometric view of the radiating coaxial cable 300 of FIG. 3A.

FIG. 3C is an end view of the radiating coaxial cable 300 of FIGS. 3A and 3B. As shown in FIG. 3C, the dielectric 302 is a cross-shaped dielectric. The cross shape in this example has 4 fins 304 extending away from the first conductor 102. Alternatively, the dielectric 302 may have fewer or more than 4 of the fins 304. The respective fins 304 may be configured to have a length (e.g., a distance from the outer surface of the first conductor 102 to the inner surface of the tape 108) and/or a thickness to support wireless applications in a particular frequency range.

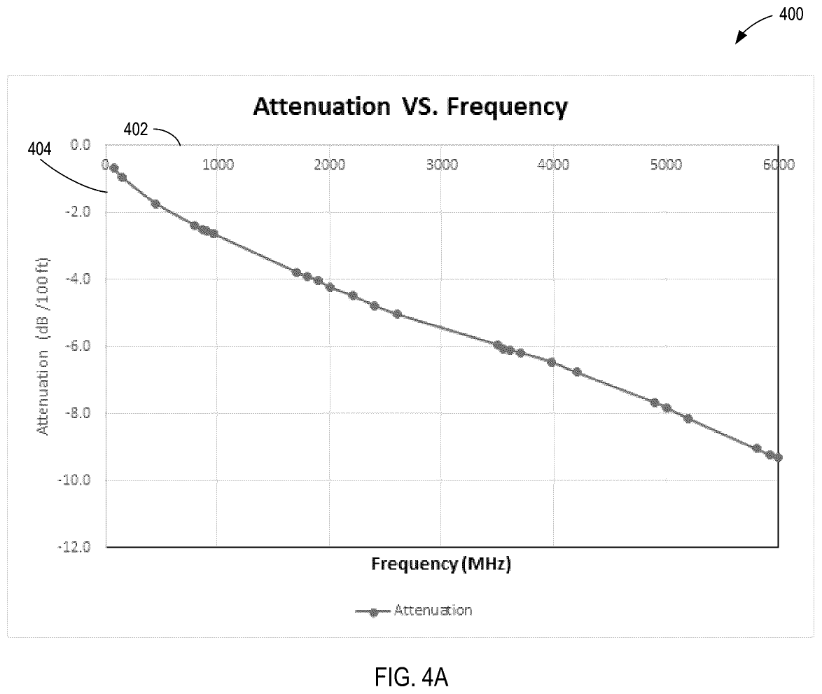

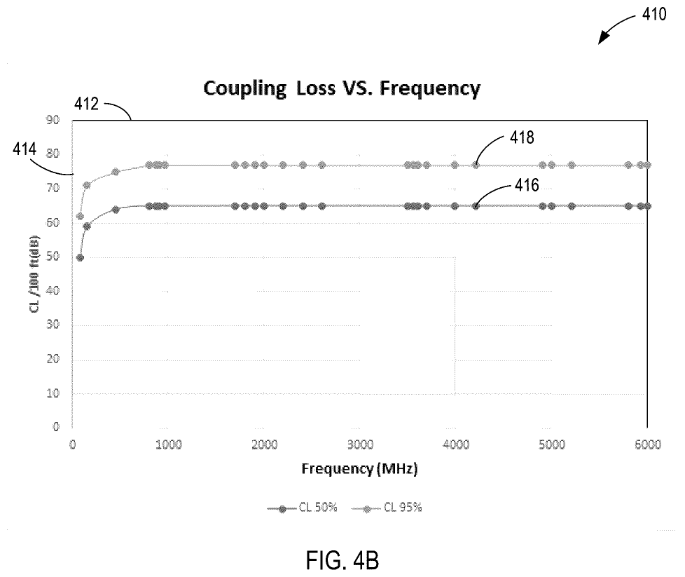

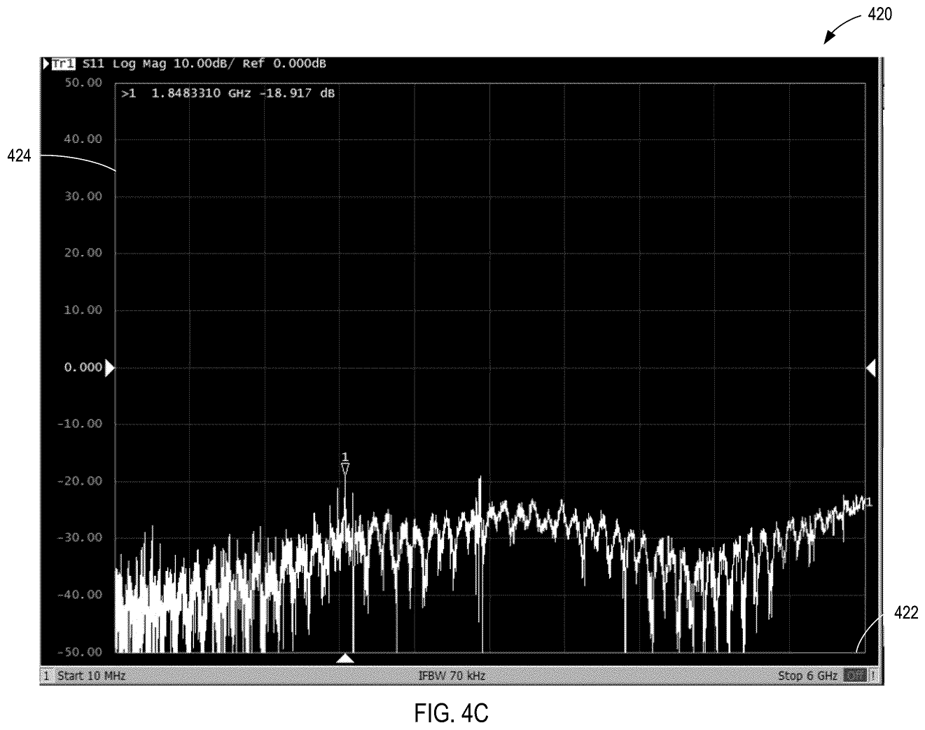

FIG. 4A is a plot 400 of attenuation characteristics of the radiating coaxial cable 100, 200, 300 of FIGS. 1, 2A, and/or 3A with respect to frequency. The plot 400 of FIG. 4A has an x-axis 402 representative of frequency in MHz and a y-axis 404 representative of attenuation in decibels per 100 feet (dB/100 ft). Beneficially, as shown in the plot 400, the radiating cable 100, 200, 300 is operable to effectuate wireless communication in a frequency range of 10 to 6000 MHz (i.e., 6 GHz) with an attenuation at 6000 MHz of approximately −9.6 dB/100 feet.

FIG. 4B is a plot 410 of coupling loss characteristics of the radiating coaxial cable 100, 200, 300 of FIGS. 1, 2A, and/or 3A with respect to frequency. Coupling loss, which may also be referred to as connection loss, may refer to the loss of power that occurs when energy is transferred from one circuit element or propagation medium to another.

The plot 410 of FIG. 4B has an x-axis 412 representative of frequency in MHz and a y-axis 414 representative of coupling loss per 100 feet (CL/100 ft). The plot 410 includes first data 416 representative of 50% coupling loss, which corresponds to the 50% percentile indicating that 50% of the measured local values are lower than the respective data points shown in the first data 418. The plot 410 includes second data 418 representative of 95% coupling loss, which corresponds to the 95% percentile indicating that 95% of the measured local values are lower than the respective data points shown in the second data 418. Beneficially, as shown in the plot 410, the radiating cable 100, 200, 300 is operable to effectuate wireless communication in a frequency range of 10 MHz to 6 GHz with substantially similar coupling loss characteristics with respect to either 50% or 95% coupling loss in the shown frequency range.

FIG. 4C is a plot 420 of return loss characteristics of the radiating coaxial cable 100, 200, 300 of FIGS. 1, 2A, and/or 3A with respect to frequency. The plot 420 of FIG. 4C has an x-axis 422 representative of frequency in MHz in a range of 10 to 6000 MHz (i.e., 6 GHz) and a y-axis 404 representative of return loss. Beneficially, as shown in the plot 420, the radiating cable 100, 200, 300 is operable to effectuate wireless communication in a frequency range of 10 to 6000 MHz with a range bound return loss in the frequency range.

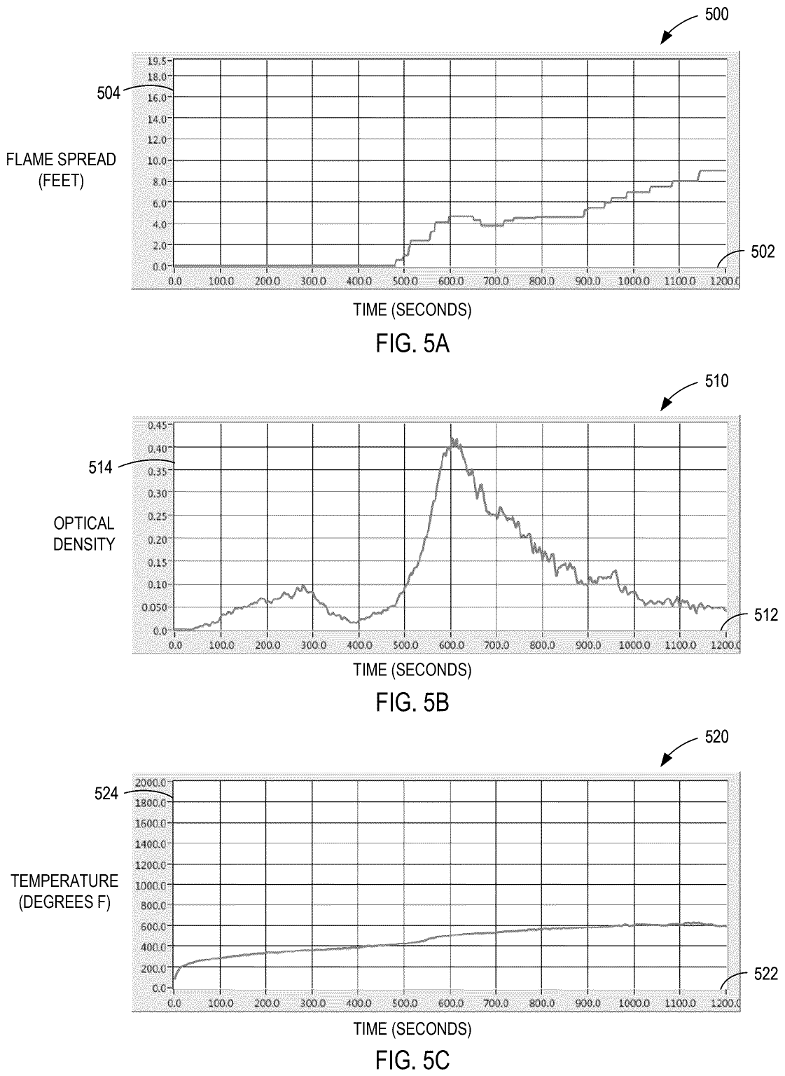

FIG. 5A is a plot 500 of flame spread with respect to time for a conventional radiating coaxial cable undergoing a flame test. For example, the plot 500 of FIG. 5A may correspond to the results of a conventional radiating cable undergoing a flame test, such as a flame test specified by NFPA 262. In such an example, the conventional radiating cable does not include the tape 108 of FIG. 1A.

The plot 500 of FIG. 5A has an x-axis 502 of time in seconds (sec) and a y-axis 504 of flame spread in feet (ft). As shown, once the outer jacket of the conventional radiating cable has been penetrated at approximately 480 seconds, the flame spread increases beyond the maximum flame spread distance of 1.5 meters (approximately 5 feet) specified by NFPA 262 at approximately 890 seconds. Thus, as shown in the plot 500 of FIG. 5A, the conventional radiating cable without the tape 108 failed the flame test.

FIG. 5B is a plot 510 of optical density with respect to time for a conventional radiating coaxial cable undergoing a flame test. For example, the plot 510 of FIG. 5B may correspond to the results of a conventional radiating cable undergoing a flame test, such as a flame test specified by NFPA 262 and also corresponding to the results shown in the plot 500 of FIG. 5A. In such an example, the plot 500 of FIG. 5A and the plot 510 of FIG. 5B may be generated using data from the same flame test. The conventional radiating cable under test does not include the tape 108 of FIG. 1A.

The plot 510 of FIG. 5B has an x-axis 512 of time in seconds (sec) and a y-axis 514 of optical density, which is unitless. As shown, once the outer jacket of the conventional radiating cable has been penetrated at approximately 480 seconds (as indicated by the plot 500 of FIG. 5A), the average optical density increases beyond the average optical density of 0.15 specified by NFPA 262. Thus, as shown in the plot 510 of FIG. 5A, the conventional radiating cable without the tape 108 failed the flame test.

FIG. 5C is a plot 520 of temperature with respect to time for a conventional radiating coaxial cable undergoing a flame test. For example, the plot 520 of FIG. 5C may correspond to the results of a conventional radiating cable undergoing a flame test, such as a flame test specified by NFPA 262 and also corresponding to the results shown in the plot 500 of FIG. 5A and/or the plot 510 of FIG. 5B. In such an example, the plot 500 of FIG. 5A, the plot 510 of FIG. 5B, and the plot 520 of FIG. 5C may be generated using data from the same flame test. The conventional radiating cable under test does not include the tape 108 of FIG. 1A.

The plot 520 of FIG. 5C has an x-axis 522 of time in seconds (sec) and a y-axis 524 of temperature in degrees F. The temperature represented by the y-axis 524 may be the temperature in the surrounding environment, such as the ambient temperature, of the conventional radiating cable undergoing the flame test. As shown, the ambient temperature increases throughout the flame test, which indicates that the construction of the conventional radiating cable does not reduce the ambient temperature. For example, the construction of the conventional radiating cable may cause the ambient temperature to rise. In such an example, once the outer jacket is penetrated during the flame test, air can enter the interior of the cable (e.g., due to the lack of sealing from the tape 108) leading to increased burning of the cable and further contributing to the ambient temperature rise.

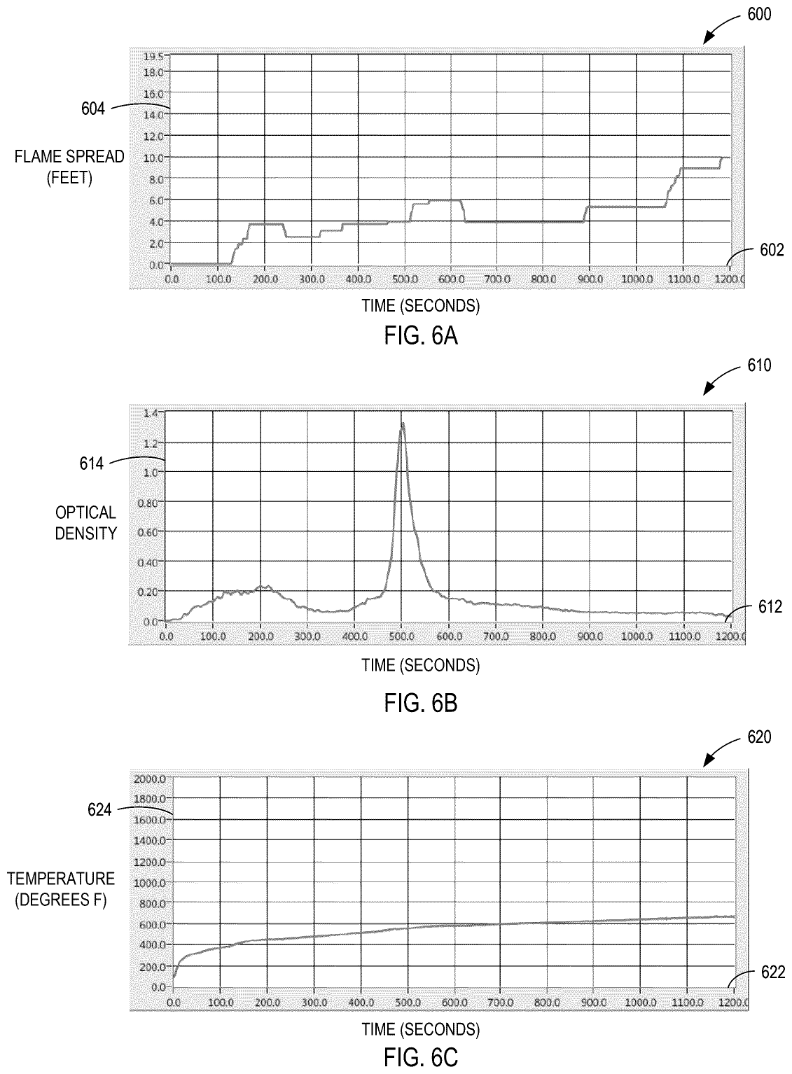

FIG. 6A is a plot 600 of flame spread with respect to time for a conventional radiating coaxial cable that includes fire-retardant tape but not the tape 108 of FIG. 1A and undergoing a flame test. For example, the plot 600 of FIG. 6A may correspond to the results of a conventional radiating cable undergoing a flame test, such as a flame test specified by NFPA 262.

The plot 600 of FIG. 6A has an x-axis 602 of time in seconds (sec) and a y-axis 604 of flame spread in feet (ft). As shown, once the outer jacket of the conventional radiating cable has been penetrated at approximately 480 seconds, the flame spread increases beyond the maximum flame spread distance of 1.5 meters (approximately 5 feet) specified by NFPA 262 at approximately 520 seconds. Thus, as shown in the plot 600 of FIG. 6A, the conventional radiating cable including fire-retardant tape but without the tape 108 failed the flame test.

FIG. 6B is a plot 610 of optical density with respect to time for a conventional radiating coaxial cable that includes fire-retardant tape but not the tape 108 of FIG. 1A undergoing a flame test. For example, the plot 610 of FIG. 6B may correspond to the results of a conventional radiating cable undergoing a flame test, such as a flame test specified by NFPA 262 and also corresponding to the results shown in the plot 600 of FIG. 6A. In such an example, the plot 600 of FIG. 6A and the plot 610 of FIG. 6B may be generated using data from the same flame test.

The plot 610 of FIG. 6B has an x-axis 612 of time in seconds (sec) and a y-axis 614 of optical density, which is unitless. As shown, once the outer jacket of the conventional radiating cable has been penetrated at approximately 480 seconds (as indicated by the spike in optical density in the plot 610), the optical density increases beyond the maximum peak optical density of 0.50 specified by NFPA 262. For example, at approximately 505 seconds, the optical density increases to approximately 1.3, which is greater than the peak optical density of 0.50 specified by NFPA 262. Thus, as shown in the plot 610 of FIG. 6A, the conventional radiating cable including the fire-retardant tape and without the tape 108 failed the flame test.

FIG. 6C is a plot 620 of temperature with respect to time for a conventional radiating coaxial cable that includes fire-retardant tape but not the tape 108 of FIG. 1A undergoing a flame test. For example, the plot 620 of FIG. 6C may correspond to the results of a conventional radiating cable undergoing a flame test, such as a flame test specified by NFPA 262 and also corresponding to the results shown in the plot 600 of FIG. 6A and/or the plot 610 of FIG. 6B. In such an example, the plot 600 of FIG. 6A, the plot 610 of FIG. 6B, and the plot 620 of FIG. 6C may be generated using data from the same flame test. The conventional radiating cable under test includes the fire-retardant tape but not the tape 108 of FIG. 1A.

The plot 620 of FIG. 6C has an x-axis 622 of time in seconds (sec) and a y-axis 624 of temperature in degrees F. The temperature represented by the y-axis 624 may be the temperature in the surrounding environment, such as the ambient temperature, of the conventional radiating cable undergoing the flame test. As shown, the ambient temperature increases throughout the flame test, which indicates that the construction of the conventional radiating cable does not reduce the ambient temperature. For example, the construction of the conventional radiating cable may cause the ambient temperature to rise. In such an example, once the outer jacket is penetrated during the flame test, air can enter the interior of the cable (e.g., due to the lack of sealing from the tape 108) leading to increased burning of the cable and further contributing to the ambient temperature rise.

Further, the ambient temperature shown in the plot 620 of FIG. 6C increases to a higher maximum ambient temperature, which is approximately 650 degrees F., than the maximum ambient temperature shown in the plot 520 of FIG. 5C, which is approximately 600 degrees F. This occurs because the presence of the fire-retardant tape in the conventional radiating cables of the examples of FIGS. 6A-6C provides additional flammable surface area that when burned can lead to increased ambient temperature and smoke levels.

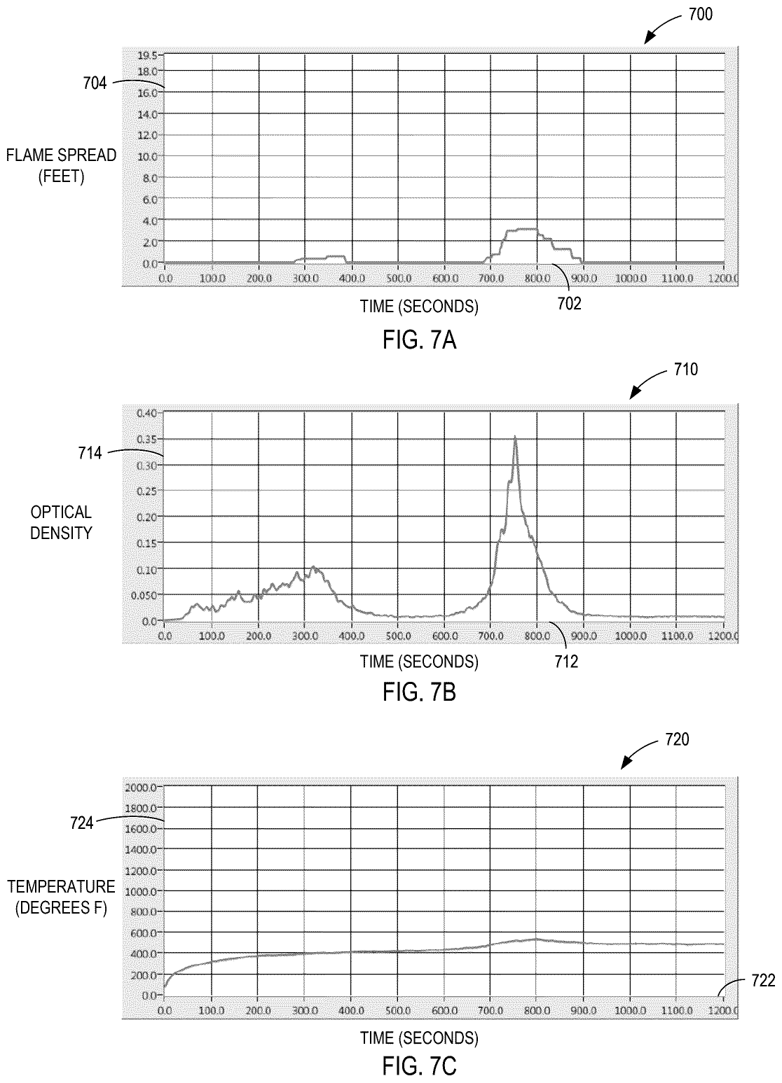

FIG. 7A is a plot 700 of flame spread with respect to time for the radiating cable 100, 200, 300 of FIGS. 1A, 2A, and/or 3A undergoing a flame test. For example, the plot 700 of FIG. 7A may correspond to the results of the radiating cable 100 of FIG. 1A undergoing a flame test, such as a flame test specified by NFPA 262.

The plot 700 of FIG. 7A has an x-axis 702 of time in seconds (sec) and a y-axis 704 of flame spread in feet (ft). As shown, the flame spread does not increase beyond the maximum flame spread distance of 1.5 meters (approximately 5 feet) specified by NFPA 262 for the duration of the flame test. Thus, as shown in the plot 700 of FIG. 7A, the radiating cable 100, 200, 300 including the tape 108 passed the flame test.

FIG. 7B is a plot 710 of optical density with respect to time for the radiating cable 100, 200, 300 of FIGS. 1A, 2A, and/or 3A undergoing a flame test. For example, the plot 710 of FIG. 7B may correspond to the results of the radiating cable 100, 200, 300 undergoing a flame test, such as a flame test specified by NFPA 262 and also corresponding to the results shown in the plot 700 of FIG. 7A. In such an example, the plot 700 of FIG. 7A and the plot 710 of FIG. 7B may be generated using data from the same flame test.

The plot 710 of FIG. 7B has an x-axis 712 of time in seconds (sec) and a y-axis 714 of optical density, which is unitless. As shown, the optical density does not increase beyond the maximum peak optical density of 0.50 specified by NFPA 262. For example, at approximately 750 seconds, the optical density increases to approximately 0.35, which is less than the peak optical density of 0.50 specified by NFPA 262. Further, as shown, the average optical density does not increase beyond the average optical density of 0.15 specified by NFPA 262. Thus, as shown in the plot 710 of FIG. 7A, the radiating cable 100, 200, 300 including the tape 108 passed the flame test.

FIG. 7C is a plot 720 of temperature with respect to time for the radiating cable 100, 200, 300 of FIGS. 1A, 2A, and/or 3A undergoing a flame test. For example, the plot 720 of FIG. 7C may correspond to the results of the radiating cable 100, 200, 300 undergoing a flame test, such as a flame test specified by NFPA 262 and also corresponding to the results shown in the plot 700 of FIG. 7A and/or the plot 710 of FIG. 7B. In such an example, the plot 700 of FIG. 7A, the plot 710 of FIG. 7B, and the plot 720 of FIG. 7C may be generated using data from the same flame test.

The plot 720 of FIG. 7C has an x-axis 722 of time in seconds (sec) and a y-axis 724 of temperature in degrees F. The temperature represented by the y-axis 724 may be the temperature in the surrounding environment, such as the ambient temperature, of the radiating cable 100, 200, 300 undergoing the flame test. As shown, the ambient temperature increases during the flame test but does not rise above the maximum ambient temperatures shown in the plot 520 of FIG. 5C and plot 620 of FIG. 6C. For example, the construction of the radiating cable 100, 200, 300 may cause the ambient temperature to rise but not to the extent the conventional radiating cables cause the ambient temperature to rise in their flame tests. In such an example, once the jacket 110 of the radiating cables 100, 200, 300 is penetrated during the flame test, the tape 108 can seal the interior of the cable and thereby reduce air inflow to the cable, which leads to burning of the cable at a reduced rate with respect to conventional radiating cables and contributes to a reduced rate of ambient temperature rise with respect to conventional radiating cables.

Further, the ambient temperature shown in the plot 720 of FIG. 7C increases to a lower maximum ambient temperature, which is approximately 550 degrees F., than the maximum ambient temperature shown in the plot 520 of FIG. 5C, which is approximately 600 degrees F., and the maximum ambient temperature shown in the plot 620 of FIG. 6C, which is approximately 650 degrees F. This occurs because the inclusion of the tape 108 in the radiating cables 100, 200, 300 seals the interior of the radiating cables 100, 200, 300 from air intake, which leads to decreased maximum ambient temperature levels and decreased smoke levels (from less burning).

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

1. A radiating coaxial cable comprising:
a first conductor;
a dielectric disposed over the first conductor;
a second conductor comprising a plurality of slots, the dielectric being disposed between the first and second conductors; and
a tape disposed over the second conductor configured to seal the plurality of slots, the tape having a thickness in a range of 0.5 to 2.0 mils.

2. The radiating coaxial cable of claim 1, wherein the tape has a thickness in a range of 0.95 to 1.05 mils.

3. The radiating coaxial cable of claim 1, wherein the tape has a width in a range of 0.5 to 1.5 inches.

4. The radiating coaxial cable of claim 3, wherein tape has a width in a range of 0.95 to 1.05 inches.

5. The radiating coaxial cable of claim 1, wherein the tape comprises a fluoropolymer.

6. The radiating coaxial cable of claim 5, wherein the fluoropolymer is selected from a group consisting of polyvinylfluoride (PVF), polyvinylidene fluoride (PVDF), polytetrafluoroethylene (PTFE), polychlorotrifluoroethylene (PCTFE), PFA, perfluoroalkoxy polymer (MFA), fluorinated ethylene-propylene (FEP), polyethylenetetrafluoroethylene (ETFE), polyethylenechlorotrifluoroethylene (ECTFE), Perfluorinated Elastomer [Perfluoroelastomer](FFPM/FFKM), Fluoroelastomer [Vinylidene Fluoride based copolymers](FPM/FKM), Fluoroelastomer [Tetrafluoroethylene-Propylene](FEPM), Perfluoropolyether (PFPE), Perfluorosulfonic acid (PFSA), and Perfluoropolyoxetane.

7. (canceled)

8. The radiating coaxial cable of claim 1, wherein the tape comprises a polymer comprising aromatic cycles or heterocycles.

9. The radiating coaxial cable of claim 8, wherein the polymer is selected from a group consisting of Polyimides, polybenzoxazoles (PBOs), polybenzimidazoles, and polybenzthiazoles (PBTs).

10. The radiating coaxial cable of claim 8, wherein the polymer comprises a ladder polymer.

11. (canceled)

12. The radiating coaxial cable of claim 1, wherein the tape comprises inorganic and/or semiorganic polymers.

13. The radiating coaxial cable of claim 12, wherein the inorganic and/or semiorganic polymers comprise silicon-nitrogen, boron-nitrogen, and/or phosphorous-nitrogen monomers.

14. The radiating coaxial cable of claim 1, wherein the tape comprises at least one of natural fiber, clay, silica, titania, carbon nanotubes, polyhedral silsesquioxanes, or layered double hydroxides.

15-25. (canceled)

26. The radiating coaxial cable of claim 1, wherein the dielectric has a nominal thickness around the first conductor in a range of 5 to 15 mils.

27. The radiating coaxial cable of claim 1, wherein the dielectric is configured to have a star shape.

28. The radiating coaxial cable of claim 27, wherein the star shaped dielectric comprises at least five fins extending away from the first conductor.

29. The radiating coaxial cable of claim 1, wherein the dielectric is configured to have a cross shape.

30. The radiating coaxial cable of claim 29, wherein the cross-shaped dielectric comprises at least four fins extending away from the first conductor.

31. (canceled)

32. The radiating coaxial cable of claim 1, wherein the cable is configured to radiate electromagnetic waves in a frequency range of 75 megahertz (MHz) to 6 gigahertz (GHz).

33. The radiating coaxial cable of claim 32, wherein the first conductor is configured to effectuate fifth generation cellular (5G) communication in the frequency range of 75 MHz to 6 GHz through the plurality of slots in the second conductor.

34. The radiating coaxial cable of claim 1, further comprising a jacket disposed over the tape.

35. The radiating coaxial cable of claim 34, wherein the tape is configured to reduce an amount of at least one of the jacket or the dielectric consumed in fire conditions, and the reduced amount of the at least one of the jacket or the dielectric causes at least one of reduced smoke generation, ambient temperature, or flame travel in the fire conditions.

36. A radiating coaxial cable comprising:
a first conductor;
a dielectric disposed over the first conductor;
a second conductor comprising a plurality of slots, the dielectric being disposed between the first and second conductors; and
a tape disposed over the second conductor and the plurality of slots, the tape comprising at least one polyimide, and the tape having a thickness in a range of 0.5 to 2.0 mils.

37. A radiating coaxial cable comprising:
a first conductor;
a dielectric disposed over the first conductor;
a second conductor comprising a plurality of slots, the dielectric being disposed between the first and second conductors; and
a tape disposed over the second conductor and the plurality of slots, the tape comprising polytetrafluoroethylene (PTFE), and the tape having a thickness in a range of 0.5 to 2.0 mils.
